(19) United States
(12) Patent Application Publication
(10) Pub. No.: US 2026/0024109 A1
(43) Pub. Date: Jan. 22, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Seitaro MURA, Tokyo (JP)

(21) Appl. No.: 19/206,883

(22) Filed: May 13, 2025

(30) Foreign Application Priority Data
Jul. 19, 2024 (JP) 2024-116067

(51) Int. Cl. G06Q 30/0242

(52) U.S. Cl. CPC G06Q 30/0246

(57) ABSTRACT

An information processing apparatus includes, a generation unit that generates meta information regarding an advertisement by using text information regarding the advertisement and image information regarding advertisement; and a prediction unit that predicts a conversion probability at which a user who has taken a predetermined action with respect to the advertisement will reach a predetermined conversion by using the meta information generated by the generation unit.

### CROSS-REFERENCE TO RELATED APPLICATIONS

The present application claims priority to and incorporates by reference the entire contents of Japanese Patent Application No. 2024-116067 filed in Japan on Jul. 19, 2024.

### BACKGROUND OF THE INVENTION

### 1. Field of the Invention

The present application relates to an information processing apparatus, an information processing method, and an information processing program.

### 2. Description of the Related Art

Conventionally, in a case where information such as an advertisement or an e-mail is distributed, there has been known a technology of predicting the number of users who reach a conversion through the distributed information among all users who are distribution destinations of the information (for example, JP 2020-187697 A).

However, the conventional technology has room for improvement in predicting a final achievement obtained through an advertisement by using information regarding the advertisement submitted by an advertiser.

### SUMMARY OF THE INVENTION

An information processing apparatus includes, a generation unit that generates meta information regarding an advertisement by using text information regarding the advertisement and image information regarding advertisement; and a prediction unit that predicts a conversion probability at which a user who has taken a predetermined action with respect to the advertisement will reach a predetermined conversion by using the meta information generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing an example of information processing according to an embodiment;

FIG. 2 is a diagram illustrating an outline regarding generation of meta information according to the embodiment;

FIG. 3 is a diagram illustrating an example of a specific procedure of a method for generating meta information according to the embodiment;

FIG. 4 is a diagram illustrating an example of second instruction information according to the embodiment;

FIG. 5 is a diagram for describing an outline of meta information according to the embodiment;

FIG. 6 is a diagram illustrating a system configuration example of an information processing system according to the embodiment;

FIG. 7 is a diagram illustrating a configuration example of an information processing apparatus according to the embodiment;

FIG. 8 is a diagram illustrating an outline of advertisement information stored in an advertisement information storage unit according to the embodiment;

FIG. 9 is a diagram illustrating an outline of user information stored in a user information storage unit according to the embodiment;

FIG. 10 is a diagram illustrating an outline of model information stored in a model information storage unit according to the embodiment;

FIG. 11 is a flowchart illustrating an example of a procedure of information processing executed by the information processing apparatus according to the embodiment; and

FIG. 12 is a hardware configuration diagram illustrating an example of a computer that achieves functions of the information processing apparatus according to the embodiment.

### DETAILED DESCRIPTION OF THE PREFERRED EMBODIMENTS

Hereinafter, a mode (hereinafter, referred to as an “embodiment”) for implementing an information processing apparatus, an information processing method, and an information processing program according to the present application will be described in detail with reference to the drawings. Note that the information processing apparatus, the information processing method, and the information processing program according to the present application are not limited by this embodiment. In addition, each embodiment can be appropriately combined within a range in which the processing contents do not contradict each other. In addition, in each embodiment described below, the same parts are denoted by the same reference numerals, and redundant description will be omitted.

### Embodiment

### 1. Example of Information Processing

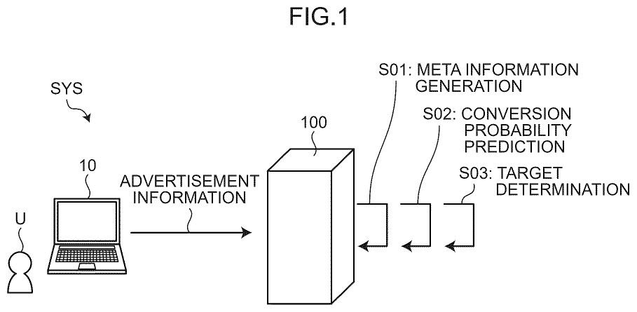

Hereinafter, an example of information processing according to an embodiment will be described with reference to the drawings. FIG. 1 is a diagram for describing an example of information processing according to an embodiment.

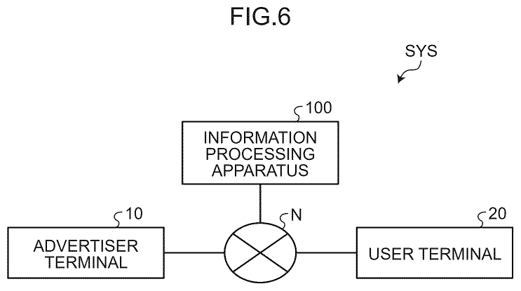

The information processing according to the embodiment is achieved by an information processing system SYS including an advertiser terminal 10 illustrated in FIG. 1 and an information processing apparatus 100 illustrated in FIG. 1. Each of the advertiser terminal 10 and the information processing apparatus 100 is connected to a network N (see, for example, FIG. 6) in a wired or wireless manner. The advertiser terminal 10 and the information processing apparatus 100 can communicate with other apparatuses through the network N.

The advertiser terminal 10 is an information processing terminal used by an advertiser U. The advertiser U submits advertisement information regarding an advertisement desired to be distributed to the information processing apparatus 100. The advertisement information submitted by the advertiser U includes submission information (an example of “text information”) that can be freely input by the advertiser regarding the advertisement, and advertisement creatives such as a moving image, a banner, and a flier created by the advertiser for advertisement.

The information processing apparatus 100 is operated and managed by a service provider that executes processing regarding distribution of an advertisement submitted by the advertiser U. For example, the service provider can distribute the advertisement in the form of display advertisement (also referred to as “banner advertisement”) through a website of various online services operated by the service provider. The information processing apparatus 100 manages the advertisement information received from the advertiser terminal 10 in association with the advertiser U.

Conventionally, when a target to be a distribution destination of an advertisement is determined, distribution records such as an actual conversion probability and a click rate are used. However, there is a possibility that log information such as distribution records will be difficult to output in the future due to privacy regulations (3rd party cookie regulations).

On the other hand, the information regarding the advertisement includes submission information submitted by an advertiser and an advertisement creative. However, since the submission information is unstructured information with no restriction on an input method, there is a case where noise is included in the information or the information is missing, and the submission information is not well utilized for predicting a final achievement of advertisement such as a conversion probability. In addition, an advertisement creative is also focused on points that attract user's interest, and is not necessarily produced so as to easily recall the relevance with products or merchandise depending on products or merchandise to be advertised, and it is difficult to extract features of an advertisement creative, and it is currently not utilized to predict a final achievement of advertisement.

Therefore, an object of the information processing apparatus 100 according to the embodiment is to predict a final achievement obtained through advertisement by successfully utilizing submission information submitted by an advertiser and an advertisement creative.

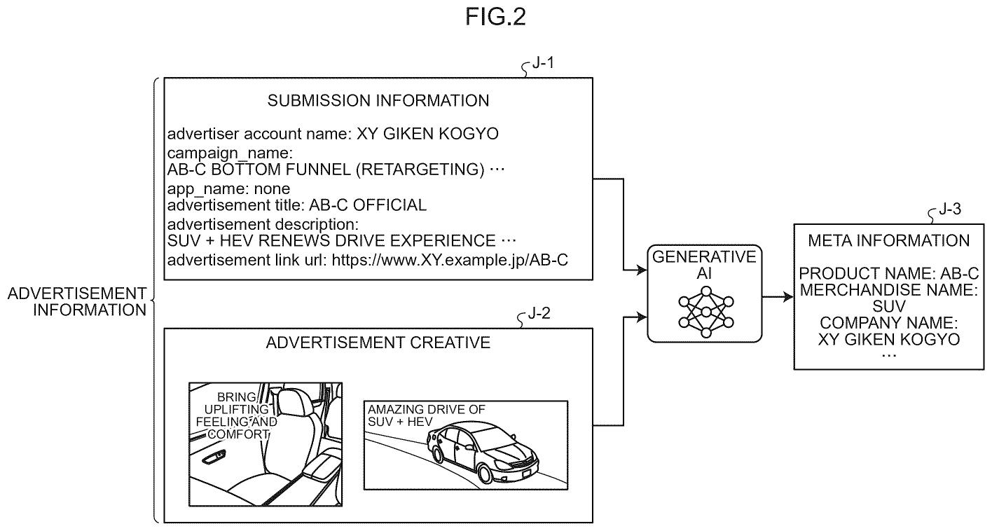

As illustrated in FIG. 1, the information processing apparatus 100 generates meta information regarding an advertisement by using submission information that is text information regarding the advertisement acquired from the advertiser U and an advertisement creative that is image information regarding the advertisement acquired from the advertiser U (Step S01). FIG. 2 is a diagram illustrating an outline regarding generation of meta information according to the embodiment.

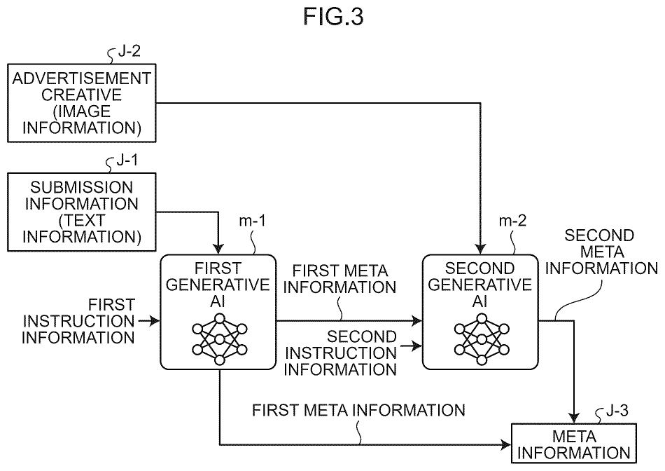

For example, as illustrated in FIG. 2, the information processing apparatus 100 inputs text information J-1 acquired as submission information, image information J-2 acquired as an advertisement creative, and information (also referred to as a “prompt”) of an instruction sentence instructing to input inference or extraction of information not included in the text information from the image information in consideration of the context of the text information, to a generative AI trained to generate an answer to an input question, thereby generating meta information J-3 including information output from the generative AI. FIG. 3 is a diagram illustrating an example of a specific procedure of a method for generating meta information according to the embodiment.

As illustrated in FIG. 3, the information processing apparatus 100 acquires first meta information from a first generative AI m-1, first, by inputting the text information J-1 and first instruction information that is information of an instruction sentence instructing to extract meta information from the text information J-1 according to a predetermined format to the first generative AI m-1 trained to generate an answer to an input question.

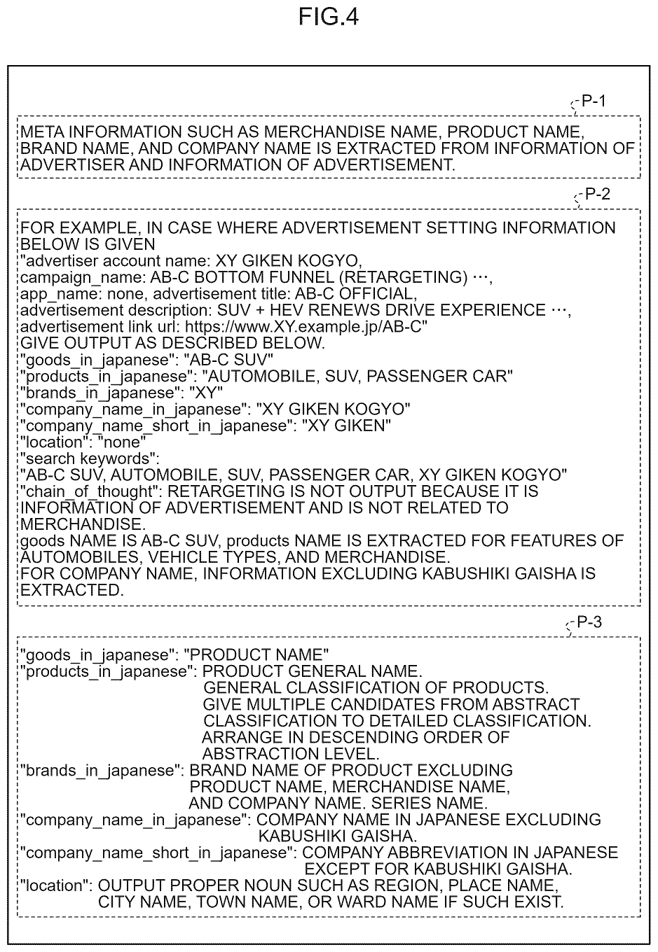

Next, the information processing apparatus 100 acquires second meta information output from a second generative AI m-2 by inputting the acquired first meta information, the image information J-2, and second instruction information that is information of an instruction sentence instructing to infer or extract information not included in the text information J-1 from the image information J-2 according to a predetermined output format to the second generative AI m-2 that is a trained model corresponding to multimodal input and trained to generate an answer to an input question. FIG. 4 is a diagram illustrating an example of second instruction information according to the embodiment.

As illustrated in FIG. 4, the second instruction information includes task definition information P-1, task execution support information P-2, and output item definition information P-3.

In the task definition information P-1, a task to be executed by the second generative AI m-2 is defined. As a result, the range of the task executed by the second generative AI m-2 becomes clear, and it is possible to prevent rework and the like.

The task execution support information P-2 gives a correct answer example of the content to be output as the task to the second generative AI m-2. As a result, the inference accuracy of the second generative AI m-2 can be improved. In addition, the task execution support information P-2 gives an output instruction of a thought process from the input information to the final output by inference or extraction to the second generative AI m-2. As a result, the service provider can tune the second instruction information by referring to a process of thought in which the second generative AI m-2 reaches a final output and changing how to give a correct answer example in the second instruction information.

In the output item definition information P-3, the definition of information to be output for each item by the second generative AI m-2 is given.

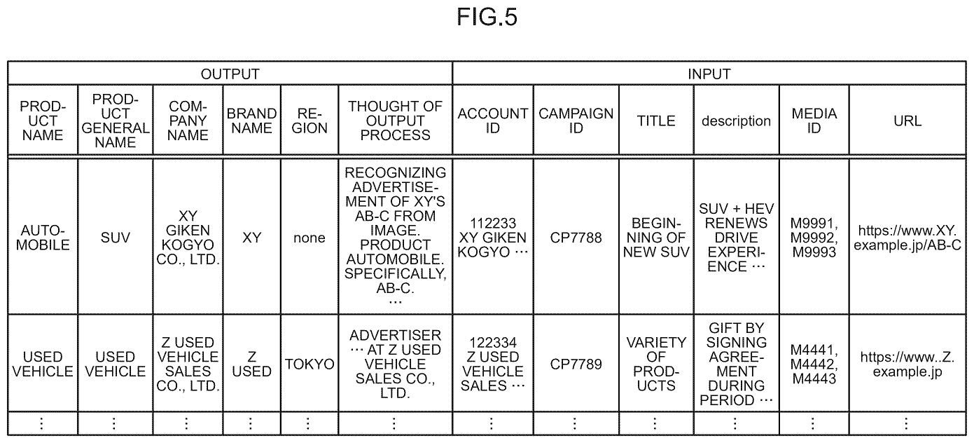

Referring back to FIG. 3, the information processing apparatus 100 generates the meta information J-3 regarding an advertisement by using the first meta information and the second meta information. FIG. 5 is a diagram for describing an outline of meta information according to the embodiment. FIG. 5 illustrates final outputs by the second generative AI m-2 and corresponding inputs.

The information processing apparatus 100 can generate the meta information J-3 including the first meta information extracted from the text information by the first generative AI m-1 and the second meta information inferred or extracted from the image information J-2 by the second generative AI m-2 in consideration of the context of the first meta information. For example, as illustrated in FIG. 5, the meta information J-3 includes a thought of an output process output from the second generative AI m-2. For example, based on a product name included in the first meta information, the second generative AI m-2 infers that the image information J-2 is an image of a product corresponding to the product name, and attempts to extract information from the image information.

Referring back to FIG. 1, the information processing apparatus 100 predicts a conversion probability at which a user who has taken a predetermined action with respect to an advertisement will reach a predetermined conversion by using the generated meta information (for example, the meta information J-3 illustrated in FIG. 2) (Step S02).

For example, in a case where the conversion is a document request from a website associated with a display advertisement by the user who has accessed the display advertisement, the information processing apparatus 100 can predict the conversion probability corresponding to a combination of the meta information and the user information regarding a candidate user by using, as training data, the conversion record of the distributed display advertisement (hereinafter, referred to as a “distributed advertisement”) by using a prediction model that is a trained model trained by machine learning for a relationship between a combination of the meta information regarding the distributed advertisement and the user information regarding a distribution destination user to which the distributed advertisement has been distributed and a conversion probability at which the distribution destination user has reached a predetermined conversion.

Specifically, the information processing apparatus 100 can create the prediction model described above by causing the trained model to perform learning such that the higher the conversion probability corresponding to the combination of the meta information and the user information, the higher the score output, using the conversion record of the distributed advertisement as the training data. Note that the user information regarding the candidate user includes, for example, attribute information such as the age, gender, and residence of the candidate user, history information such as a browsing history and a purchasing history of the candidate user in an online service, and the like. Then, the information processing apparatus 100 can predict the conversion probability corresponding to the meta information and the user information regarding an advertisement to be processed on the basis of the score output from the prediction model by inputting the combination of the meta information and the user information to the prediction model. For example, the information processing apparatus 100 can acquire a score output from the prediction model by inputting, to the prediction model, a combination of the meta information and all user information such as attribute information such as the age, gender, and residence of the candidate user and history information such as a browsing history and a purchasing history of the candidate user in an online service, and predict the conversion probability corresponding to the combination of the user information and the meta information on the basis of the acquired score.

Note that, when predicting the conversion probability, the information processing apparatus 100 may select in advance a candidate user that can be a distribution destination of an advertisement on the basis of user information regarding a service user from among service users of various online services on the basis of the meta information. Specifically, the information processing apparatus 100 can select a candidate user by using a rule base in which a score corresponding to a combination of the user information and the meta information is set in advance. For example, in a case where a product corresponding to the meta information is a product for men, the information processing apparatus 100 selects a user whose gender is “male” as a candidate user in advance from the service users. Then, the information processing apparatus 100 inputs the combination of the user information corresponding to the candidate user selected in advance and the meta information to the prediction model, and the conversion probability corresponding to the combination of the user information and the meta information can be predicted as described above.

After predicting the conversion probability, the information processing apparatus 100 determines a target that is a distribution destination user of an advertisement to be processed on the basis of a prediction result of the conversion probability (Step S03).

For example, the information processing apparatus 100 can predict the conversion probability for all service users of various online services, and determine, as the distribution destination user, a user matching the user information whose conversion probability is larger than a predetermined threshold from among the service users of the various online services on the basis of the prediction result.

As described above, the information processing apparatus 100 according to the embodiment generates the meta information regarding the advertisement by using the submission information that is the text information regarding the advertisement submitted by the advertiser U and the advertisement creative that is the image information regarding the advertisement submitted by the advertiser U, and predicts the conversion probability at which the user who has taken a predetermined action with respect to the advertisement will reach the predetermined conversion by using the generated meta information. For this reason, the information processing apparatus 100 according to the embodiment can predict a final achievement obtained through advertisement by successfully utilizing submission information submitted by an advertiser and an advertisement creative.

In addition, the information processing apparatus 100 according to the embodiment may perform “Batch Prompting” that includes a plurality of advertisement campaigns (for example, an existing advertisement campaign or a new advertisement campaign) in one request for the purpose of reducing the processing cost.

In addition, the information processing apparatus 100 according to the embodiment may vectorize the meta information with a Japanese learned language model and use the vectorized meta information as the feature amount of the prediction model for the purpose of absorbing synonyms (for example, “car” and “automobile”) within the meta information generated by the generative AI.

### 2. System Configuration

Hereinafter, the configuration of the information processing system SYS according to the embodiment will be described in detail with reference to FIG. 6. FIG. 6 is a diagram illustrating a system configuration example of the information processing system SYS according to the embodiment.

As illustrated in FIG. 6, the information processing system SYS according to the embodiment includes the advertiser terminal 10, a user terminal 20, and the information processing apparatus 100. Note that FIG. 6 merely illustrates an example of the configuration of the information processing system SYS according to the embodiment, and may include a plurality of advertiser terminals 10 and a plurality of user terminals 20.

The advertiser terminal 10, the user terminal 20, and the information processing apparatus 100 are connected to the network N in a wired or wireless manner. The advertiser terminal 10, the user terminal 20, and the information processing apparatus 100 can communicate with each other through the network N.

The network N includes, for example, a wide area network (WAN) such as the Internet, or a mobile communication network such as long term evolution (LTE), 4th generation (4G), or 5th generation (5G: 5th Generation Mobile Communication System).

The advertiser terminal 10 is connected to the network N by the mobile communication network or short-range wireless communication such as Bluetooth (registered trademark) or a wireless local area network (LAN), and can communicate with other apparatuses such as the information processing apparatus 100 through the network N.

In addition, the advertiser terminal 10 is used by an advertiser (for example, the advertiser U illustrated in FIG. 1) who submits advertisement information to the information processing apparatus 100 and requests distribution of the advertisement. The advertiser terminal 10 may be, for example, a notebook personal computer (PC), a desktop PC, a smartphone, a tablet PC, or the like.

The advertiser U (see, for example, FIG. 1) can access the information processing apparatus 100 by an application programming interface (API) provided by a service provider managing the information processing apparatus 100 by operating the advertiser terminal 10, and submit advertisement information to the information processing apparatus 100. Note that a dedicated application program (hereinafter, referred to as a “dedicated app”) having various functions for submitting advertisement information to the information processing apparatus 100 may be installed in the advertiser terminal 10.

In addition, the advertiser terminal 10 can display content provided from the information processing apparatus 100 by a dedicated app, for example. Note that, in a case where the advertiser terminal 10 receives the control information for achieving the information display processing from the information processing apparatus 100, the display processing is achieved according to the control information.

The control information is described in, for example, a script language such as JavaScript (registered trademark), a style sheet language such as Cascading Style Sheets (CSS), a programming language such as Java (registered trademark), or a markup language such as HyperText Markup Language (HTML). Note that a predetermined application itself distributed from the information processing apparatus 100 or the like may be regarded as the control information.

The user terminal 20 is used by a service user of various online services. In the user terminal 20, an application program for a service user (hereinafter, referred to as a “user app”) having various functions for using various online services is installed.

The user terminal 20 may be, for example, a smartphone, a notebook personal computer (PC), a desktop PC, a tablet PC, a wearable device, or the like. Examples of the wearable device include smart glasses, smartwatches, and the like, but are not limited to such examples.

Examples of the online service provided to the service user include a news site, a search service, a travel information providing service, a social networking service (SNS), an e-commerce service, an electronic payment service, an online game, an online banking service, an online trading service, an accommodation reservation service, a ticket reservation service, a moving image distribution service, a music distribution service, a map information service, a route search service, a route guidance service, a train line information service, an operation information service, a weather information service, and a question service. Note that the various online services may include application programming interface (API) services corresponding to various applications.

In addition, the user terminal 20 can display web content provided from the information processing apparatus 100 by a user app, for example. Note that, in a case where the user terminal 20 receives the control information for achieving the information display processing from the information processing apparatus 100, the display processing is achieved according to the control information.

The control information is described in, for example, a script language such as JavaScript (registered trademark), a style sheet language such as Cascading Style Sheets (CSS), a programming language such as Java (registered trademark), or a markup language such as HyperText Markup Language (HTML). Note that a predetermined application itself distributed from the information processing apparatus 100 or the like may be regarded as the control information.

The information processing apparatus 100 is operated and managed by a service provider that executes processing regarding distribution of an advertisement submitted by the advertiser U (see, for example, FIG. 1). In addition, the information processing apparatus 100 is operated and managed by a service provider that provides various online services.

For example, the service provider can distribute the advertisement in the form of display advertisement (also referred to as “banner advertisement”) through a website of various online services operated by the service provider by using the information processing apparatus 100. The information processing apparatus 100 manages the advertisement information received from the advertiser terminal 10 in association with the advertiser U.

The information processing apparatus 100 is typically a server apparatus, but may be achieved by a mainframe, a workstation, or the like. In addition, in a case where the information processing apparatus 100 is achieved by a server apparatus, the information processing apparatus 100 may be achieved by a single server apparatus, or may be achieved by a cloud system or the like in which a plurality of server apparatuses and a plurality of storage apparatuses operate in cooperation.

### 3. Apparatus Configuration

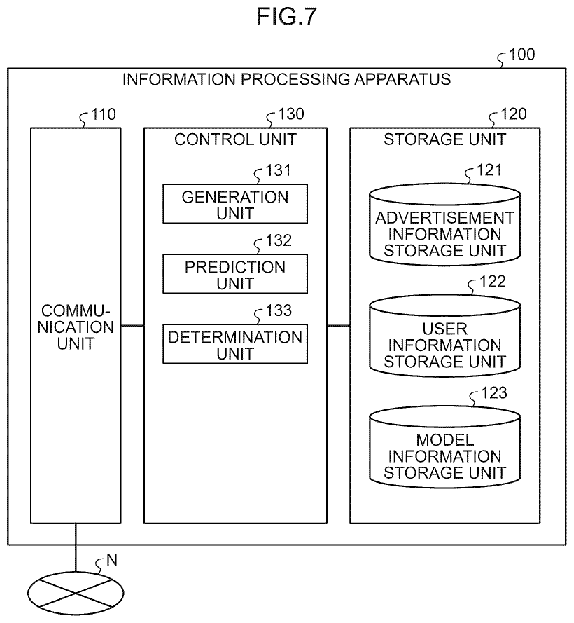

Hereinafter, an example of a functional configuration of the information processing apparatus 100 included in the information processing system SYS according to the embodiment will be described with reference to FIG. 7. FIG. 7 is a diagram illustrating a configuration example of the information processing apparatus 100 according to the embodiment. As illustrated in FIG. 7, the information processing apparatus 100 includes a communication unit 110, a storage unit 120, and a control unit 130.

### Communication Unit 110

The communication unit 110 is achieved by, for example, a communication module, a network interface card (NIC), or the like. The communication unit 110 is connected to the network N in a wired or wireless manner. The information processing apparatus 100 transmits and receives information to and from other apparatuses such as the advertiser terminal 10 via the network N.

### Storage Unit 120

The storage unit 120 stores, for example, a program and data used for control and calculation by the control unit 130. For example, the storage unit 120 is achieved by a semiconductor memory element such as random access memory (RAM) or flash memory, or a storage apparatus such as a hard disk or an optical disk. For example, the storage unit 120 includes an advertisement information storage unit 121, a user information storage unit 122, and a model information storage unit 123. Note that the storage unit 120 is not particularly limited to the example illustrated in FIG. 7, and can appropriately store data and the like necessary for executing the information processing according to the embodiment.

### Advertisement Information Storage Unit 121

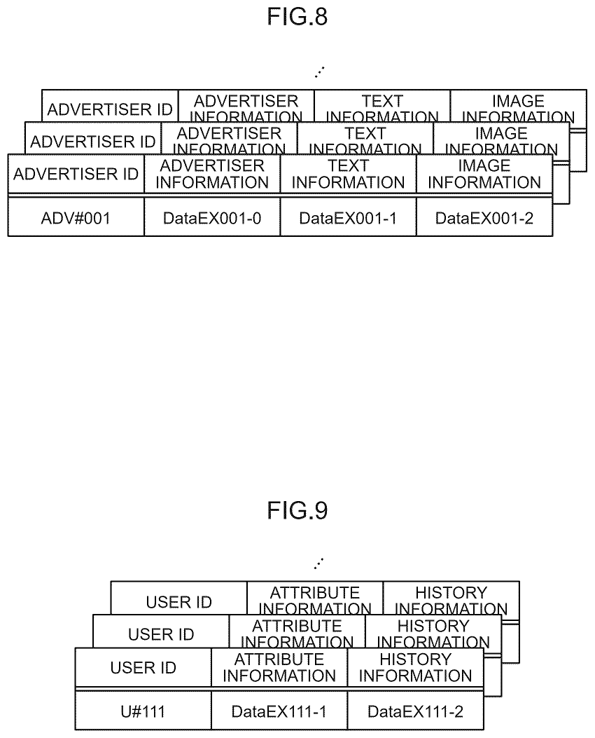

The advertisement information storage unit 121 stores advertisement information submitted by an advertiser. FIG. 8 is a diagram illustrating an outline of advertisement information stored in the advertisement information storage unit 121 according to the embodiment.

As illustrated in FIG. 8, the advertisement information stored in the advertisement information storage unit 121 includes a plurality of items such as an item of “advertiser ID”, an item of “advertiser information”, an item of “text information”, and an item of “image information”. These items included in the user information are associated with each other.

In the item of “advertiser ID”, identification information for identifying an advertiser (for example, the advertiser U illustrated in FIG. 1) is stored. In the item of “advertiser information”, information regarding an advertiser is stored. In the item of “text information”, submission information that is text information regarding an advertisement submitted by an advertiser is stored. In the item of “image information”, information of an advertisement creative that is image information regarding an advertisement submitted by an advertiser is stored.

The information regarding the advertiser, the text information, and the image information stored in the advertisement information storage unit 121 are used for generating the meta information regarding the advertisement.

### User Information Storage Unit 122

The user information storage unit 122 stores user information regarding service users of various online services. FIG. 9 is a diagram illustrating an outline of user information stored in the user information storage unit 122 according to the embodiment.

As illustrated in FIG. 9, the user information stored in the user information storage unit 122 includes an item of “user ID”, an item of “attribute information”, and an item of “history information”. These items included in the user information are associated with each other.

In the item of “user ID”, identification information for identifying service users of various online services is stored. In the item of “attribute information”, attribute information indicating an attribute of a service user is stored. The attribute information includes information regarding a psychographic attribute such as an interest and a lifestyle of the service user in addition to information regarding a demographic attribute such as the age, gender, and residence of the service user. In the item of “history information”, in addition to information indicating a history of actions such as a browsing history or a purchasing history of the service user in various online services, information indicating a history of reaction to an advertisement itself such as impression to the advertisement, click, or conversion is stored. Note that a list of advertisements clicked and converted by the user in the past is used as the feature amount for click and conversion. When there is even one click or conversion in the past, the feature amount is set to “1”, and when there is no click or conversion, the feature amount is set to “0”.

The user information stored in the user information storage unit 122 can be used, for example, in a case of determining a candidate user that can be a distribution destination of an advertisement from among service users of various online services.

### Model Information Storage Unit 123

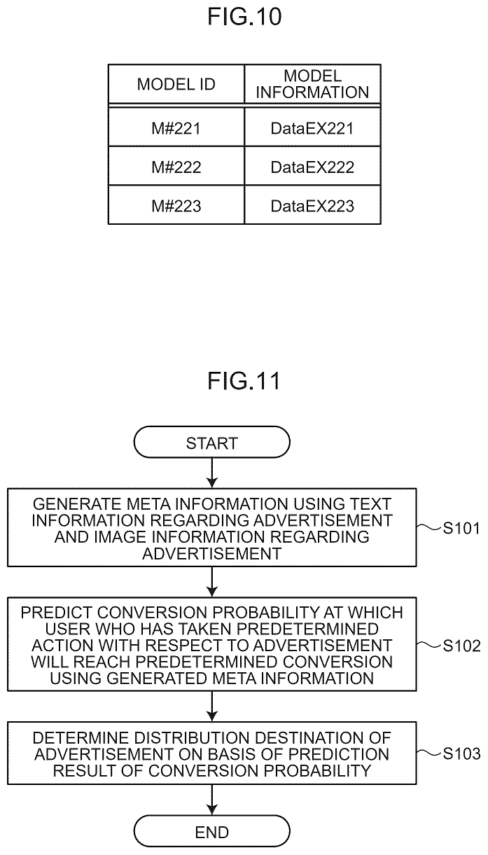

The model information storage unit 123 stores information regarding a model that executes information processing according to the embodiment. FIG. 10 is a diagram illustrating an outline of model information stored in the model information storage unit 123 according to the embodiment.

As illustrated in FIG. 10, the model information stored in the model information storage unit 123 includes a plurality of items such as an item of “model ID” and an item of “model information”. These items included in the model information are associated with each other.

In the item of “model ID”, identification information for identifying a model is stored. In the item of “model information”, information regarding the model such as information regarding an input corresponding to the model, information regarding an output output from the model (for example, the score or the like), and a weight value set to the model is stored.

The model information stored in the model information storage unit 123 includes information regarding the first generative AI m-1 (see, for example, FIG. 3) trained to generate an answer to an input question, the second generative AI m-2 (see, for example, FIG. 3) that is a trained model corresponding to multimodal input (for example, text information and image information) and trained to generate an answer to an input question, information regarding a prediction model that predicts a conversion probability for each candidate user that can be a distribution destination of an advertisement, and the like.

### Control Unit 130

The control unit 130 is a controller, and is achieved by a central processing unit (CPU), a micro processing unit (MPU), or the like executing various programs (an example of an “information processing program”) stored in a storage apparatus inside the information processing apparatus 100 using RAM as a work area.

In addition, the control unit 130 may be achieved by, for example, an integrated circuit such as an application specific integrated circuit (ASIC), a field programmable gate array (FPGA), or a general purpose graphic processing unit (GPGPU).

As illustrated in FIG. 7, the control unit 130 includes a generation unit 131, a prediction unit 132, and a determination unit 133, and these units achieve or execute a function and an operation of information processing described below.

Note that the control unit 130 may have a plurality of divided internal configurations in units of processing for achieving or executing functions and operations of information processing described below. In addition, the control unit 130 is not limited to the configuration illustrated in FIG. 7, and may have another configuration as long as the configuration performs information processing to be described below, and may have another functional unit other than the functional unit illustrated in FIG. 7.

### Generation Unit 131

The generation unit 131 generates meta information regarding an advertisement by using the text information regarding the advertisement and the image information regarding the advertisement. For example, the generation unit 131 can input text information, image information, and information of an instruction sentence instructing to infer or extract information not included in the text information from the image information by recognizing the image information in consideration of the context of the text information to a generative AI trained to generate an answer to an input question, and can generate meta information including information output from the generative AI.

Specifically, the generation unit 131 acquires the first meta information output from the first generative AI m-1 by inputting the text information J-1 and the first instruction information that is the information of the instruction sentence instructing to extract the meta information from the text information J-1 according to a predetermined format to the first generative AI m-1 (see FIG. 3) trained to generate an answer to the input question, acquires the second meta information output from the second generative AI m-2 by inputting the acquired first meta information, the image information J-2, and the information of the instruction sentence instructing to infer or extract the information not included in the text information J-1 from the image information J-2 according to a predetermined output format to the second generative AI m-2 (see FIG. 3) that is a trained model corresponding to multimodal input and trained to generate an answer to the input question, and generates the meta information by using the first meta information and the second meta information.

In addition, the generation unit 131 can also generate meta information including information of a thought process by including an output instruction of a thought process leading to a final output with respect to the second generative AI m-2 in the second instruction information that is information of an instruction sentence and inputting the second instruction information to the second generative AI m-2.

### Prediction Unit 132

Using the meta information generated by the generation unit 131, the prediction unit 132 predicts a conversion probability at which a user (for example, a service user of an online service) who has taken a predetermined action with respect to an advertisement will reach a predetermined conversion.

For example, the prediction unit 132 can predict the conversion probability corresponding to a combination of the meta information and the user information regarding a candidate user by using, as training data, the record information of the distributed advertisement (for example, a history of reaction to an advertisement itself such as an impression, a click, or a conversion record with respect to the advertisement) by using a prediction model that is a trained model trained by machine learning for a relationship between a combination of the meta information regarding the distributed advertisement and the user data regarding a distribution destination user to which the distributed advertisement has been distributed and a conversion probability at which the distribution destination user has reached a predetermined conversion. A list of advertisements clicked and converted by the user in the past is used as the feature amount for click and conversion. When there is even one click or conversion in the past, the feature amount is set to “1”, and when there is no click or conversion, the feature amount is set to “0”.

Specifically, the prediction unit 132 can create the prediction model described above by causing the trained model to perform learning such that the higher the conversion probability corresponding to the combination of the meta information and the user information, the higher the score output, using the conversion record of the distributed advertisement as the training data. The prediction unit 132 can predict the conversion probability corresponding to the meta information and the user information regarding an advertisement to be processed on the basis of the score output from the prediction model by inputting the combination of the meta information and the user information to the prediction model. For example, the prediction unit 132 acquires the conversion probability between a user and an advertisement output from the prediction model by inputting the feature of the user and the feature amount of the advertisement output to the user to the prediction model. The prediction unit 132 predicts the conversion probability for all users who use a service. Note that data regarding all users and advertisements existing as logs is used as training data used when training the prediction model. In addition, when one of the feature amounts of the advertisement is generated, a generative AI can be used.

### Determination Unit 133

The determination unit 133 determines the distribution destination of an advertisement on the basis of the prediction result of the conversion probability by the prediction unit 132. For example, the determination unit 133 can determine, as the distribution destination user, a user matching the user information whose conversion probability is larger than a predetermined threshold from among service users of various online services.

### 4. Processing Procedure According to the Embodiment

Hereinafter, a procedure of information processing executed by the information processing apparatus 100 according to the embodiment will be described. FIG. 11 is a flowchart illustrating an example of a procedure of information processing executed by the information processing apparatus 100 according to the embodiment. The processing procedure illustrated in FIG. 11 is executed by the control unit 130 of the information processing apparatus 100. The processing procedure illustrated in FIG. 11 is repeatedly executed while the information processing apparatus 100 is in operation.

As illustrated in FIG. 11, the generation unit 131 generates meta information regarding an advertisement by using the text information regarding the advertisement and the image information regarding the advertisement (Step S101).

Using the meta information generated by the generation unit 131, the prediction unit 132 predicts a conversion probability at which a user (for example, a service user of an online service) who has taken a predetermined action with respect to an advertisement will reach a predetermined conversion (Step S102).

The distribution destination of an advertisement is determined on the basis of the prediction result of the conversion probability by the prediction unit 132 (Step S103), and the processing procedure illustrated in FIG. 11 is ended.

### 5. Hardware Configuration

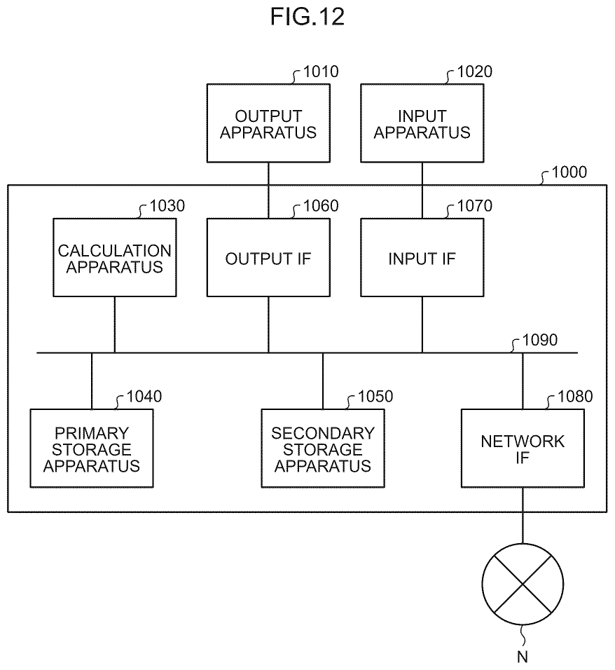

In addition, the information processing apparatus 100 according to the above-described embodiment and modifications is achieved by, for example, a computer 1000 having a configuration as illustrated in FIG. 12. FIG. 12 is a hardware configuration diagram illustrating an example of a computer that achieves functions of the information processing apparatus 100 according to the embodiment.

The computer 1000 is connected to an output apparatus 1010 and an input apparatus 1020, and has a form in which a calculation apparatus 1030, a primary storage apparatus 1040, a secondary storage apparatus 1050, an output interface (IF) 1060, an input IF 1070, and a network IF 1080 are connected by a bus 1090.

The calculation apparatus 1030 operates on the basis of a program stored in the primary storage apparatus 1040 or the secondary storage apparatus 1050, a program read from the input apparatus 1020, or the like, and executes various processing. The primary storage apparatus 1040 is a memory apparatus such as RAM that temporarily stores data used by the calculation apparatus 1030 for various types of calculation. In addition, the secondary storage apparatus 1050 is a storage apparatus in which data used for various types of calculation by the calculation apparatus 1030 and various databases are registered, and is achieved by read only memory (ROM), a HDD, flash memory, or the like.

The output IF 1060 is an interface for transmitting information to be output to the output apparatus 1010 that outputs various types of information such as a monitor and a printer, and is achieved by, for example, a connector of a standard such as a universal serial bus (USB), a digital visual interface (DVI), or a high definition multimedia interface (HDMI) (registered trademark). In addition, the input IF 1070 is an interface for receiving information from various input apparatuses 1020 such as a mouse, a keyboard, and a scanner, and is achieved by, for example, a USB or the like.

Note that the input apparatus 1020 may be, for example, an apparatus that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like. In addition, the input apparatus 1020 may be an external storage medium such as a USB memory.

The network IF 1080 receives data from another device via the network N and transmits the data to the calculation apparatus 1030, and transmits data generated by the calculation apparatus 1030 to another device via the network N.

The calculation apparatus 1030 controls the output apparatus 1010 and the input apparatus 1020 via the output IF 1060 and the input IF 1070. For example, the calculation apparatus 1030 loads a program from the input apparatus 1020 or the secondary storage apparatus 1050 onto the primary storage apparatus 1040, and executes the loaded program.

For example, in a case where the computer 1000 functions as the information processing apparatus 100 according to the embodiment, the calculation apparatus 1030 of the computer 1000 achieves the same function as the control unit 130 by executing a program (for example, information processing program) loaded on the primary storage apparatus 1040. That is, the calculation apparatus 1030 achieves processing by the information processing apparatus 100 according to the embodiment in cooperation with a program (for example, the information processing program) loaded on the primary storage apparatus 1040.

### 6. Other

Among the pieces of processing described in the above embodiment or the like, all or some of the pieces of processing described as being automatically performed can be manually performed, or all or some of the pieces of processing described as being manually performed can be automatically performed by a known method. Additionally, the processing procedure, specific name, and information including various data and parameters illustrated in the document and the drawings can be arbitrarily changed unless otherwise specified.

In addition, each component of each apparatus illustrated in the drawings is functionally conceptual, and is not necessarily physically configured as illustrated in the drawings. That is, a specific form of distribution and integration of apparatuses is not limited to the illustrated form, and all or a part thereof can be functionally or physically distributed and integrated in an arbitrary unit according to various loads, usage conditions, and the like. The functional configuration of the information processing apparatus 100 can be flexibly changed such that some of the processing functions of the information processing apparatus 100 described above are achieved by calling an external platform or the like with an application programming interface (API), network computing, or the like depending on the function. For example, the information processing apparatus 100 according to the embodiment may execute the information processing according to the embodiment by causing a trained model stored in an external information processing apparatus or the like to predict the conversion probability using the API and receiving only a prediction result from the external information processing apparatus.

In addition, each embodiment described above can be appropriately combined within a range in which the processing contents do not contradict each other.

Although the embodiments of the present application have been described in detail with reference to some drawings, these are merely examples, and the present invention can be implemented in other forms subjected to various modifications and improvements based on the knowledge of those skilled in the art, including the aspects described in the disclosure of the invention.

In addition, “section, module, and unit” described above can be read as “means”, “circuit”, or the like. For example, the control unit can be read as a control means or a control circuit.

### 7. Effects

The information processing apparatus 100 according to the embodiment includes the generation unit 131 and the prediction unit 132. The generation unit 131 generates meta information regarding an advertisement by using the text information regarding the advertisement and the image information regarding the advertisement. Using the meta information generated by the generation unit 131, the prediction unit 132 predicts a conversion probability at which a user who has taken a predetermined action with respect to an advertisement will reach a predetermined conversion.

In addition, the generation unit 131 inputs text information, image information, and information of an instruction sentence instructing to infer or extract information not included in the text information from the image information by recognizing the image information in consideration of the context of the text information to a generative AI trained to generate an answer to an input question, and generates meta information including information output from the generative AI.

In addition, the generation unit 131 acquires the first meta information output from the first generative AI by inputting the text information and the information of the instruction sentence instructing to extract the meta information from the text information according to a predetermined format to the first generative AI (see, for example, FIG. 3) trained to generate an answer to the input question, acquires the second meta information output from the second generative AI by inputting the acquired first meta information, the image information, and the information of the instruction sentence instructing to infer or extract the information not included in the text information from the image information according to a predetermined output format to the second generative AI (see, for example, FIG. 3) that is a trained model corresponding to multimodal input and trained to generate an answer to the input question, and generates the meta information by using the first meta information and the second meta information.

In addition, the generation unit 131 generates meta information including information of a thought process by including an output instruction of a thought process leading to a final output with respect to the second generative AI in the information of an instruction sentence and inputting the information to the second generative AI.

In addition, the prediction unit 132 predicts the conversion probability corresponding to a combination of the meta information and the user information regarding a candidate user who can be a candidate of the distribution destination of the advertisement by using, as training data, the conversion record of the distributed advertisement by using a trained model trained by machine learning for a relationship between a combination of the meta information regarding the distributed advertisement and the user data regarding a distribution destination user to which the distributed advertisement has been distributed and a conversion probability at which the distribution destination user has reached a predetermined conversion.

In addition, the information processing apparatus 100 further includes the determination unit 133 that determines the distribution destination of the advertisement on the basis of the prediction result of the conversion probability by the prediction unit 132.

For this reason, the information processing apparatus 100 according to the embodiment generates the meta information regarding the advertisement by using the submission information that is the text information regarding the advertisement submitted by the advertiser and the advertisement creative that is the image information regarding the advertisement submitted by the advertiser, and predicts the conversion probability at which the user who has taken a predetermined action with respect to the advertisement will reach the predetermined conversion by using the generated meta information. For this reason, the information processing apparatus 100 according to the embodiment can predict a final achievement obtained through advertisement by successfully utilizing submission information submitted by an advertiser and an advertisement creative.

In addition, the above-described effect can also be achieved by processing executed by each unit described or a combination of any of the pieces of processing executed by each unit.

According to one aspect of an embodiment, it is possible to predict a final achievement obtained through an advertisement by using information regarding the advertisement submitted by an advertiser.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a generation unit that generates meta information regarding an advertisement by using text information regarding the advertisement and image information regarding advertisement; and
a prediction unit that predicts a conversion probability at which a user who has taken a predetermined action with respect to the advertisement will reach a predetermined conversion by using the meta information generated by the generation unit.

2. The information processing apparatus according to claim 1, wherein
the generation unit
inputs the text information, the image information, and information of an instruction sentence instructing to infer or extract information not included in the text information from the image information by recognizing the image information in consideration of context of the text information to a generative AI trained to generate an answer to an input question, and generates the meta information including information output from the generative AI.

3. The information processing apparatus according to claim 2, wherein
the generation unit
acquires first meta information output from a first generative AI by inputting the text information and information of an instruction sentence instructing to extract the meta information from the text information according to a predetermined format to the first generative AI trained to generate an answer to an input question, acquires second meta information output from a second generative AI by inputting the acquired first meta information, the image information, and information of an instruction sentence instructing to infer or extract information not included in the text information from the image information according to a predetermined output format to the second generative AI that is a trained model corresponding to multimodal input and trained to generate an answer to an input question, and generates the meta information by using the first meta information and the second meta information.

4. The information processing apparatus according to claim 3, wherein
the generation unit
generates the meta information including information of a thought process by including an output instruction of the thought process leading to a final output with respect to the second generative AI in the information of the instruction sentence and inputting the information to the second generative AI.

5. The information processing apparatus according to claim 1, wherein
the prediction unit
predicts the conversion probability corresponding to a combination of the meta information and user information regarding a candidate user who is a candidate of a distribution destination of the advertisement by using, as training data, a conversion record of a distributed advertisement by using a trained model trained by machine learning for a relationship between a combination of the meta information regarding the distributed advertisement and the user information regarding a distribution destination user to which the distributed advertisement has been distributed and a conversion probability at which the distribution destination user has reached a predetermined conversion.

6. The information processing apparatus according to claim 5, further comprising:
a determination unit that determines the distribution destination of the advertisement on a basis of a prediction result of the conversion probability by prediction unit.

7. An information processing method performed by a computer, the information processing method comprising:
a generation process of generating meta information regarding an advertisement by using text information regarding the advertisement and image information regarding advertisement; and
a prediction process of predicting a conversion probability at which a user who has taken a predetermined action with respect to the advertisement will reach a predetermined conversion by using the meta information generated by the generation process.

8. A non-transitory computer-readable storage medium storing an information processing program for causing the computer to execute:
a generation procedure of generating meta information regarding an advertisement by using text information regarding the advertisement and image information regarding advertisement; and
a prediction procedure of predicting a conversion probability at which a user who has taken a predetermined action with respect to the advertisement will reach a predetermined conversion by using the meta information generated by the generation procedure.
